(19) United States
(12) Patent Application Publication
(10) Pub. No.: US 2007/0093227 A1
(43) Pub. Date: Apr. 26, 2007

(54) Frequency shifting of wcdma carriers for variable carrier separation

(76) Inventors: Tomas Lieback, Molnlycke (SE); Derek Hagen, Goteborg (SE)

Correspondence Address: NIXON & VANDERHYE, PC, 901 NORTH GLEBE ROAD, 11TH FLOOR, ARLINGTON, VA, 22203, US

(21) Appl. No.: 10/578,689

(22) PCT Filed: Nov. 24, 2003
(86) PCT No.: PCT/SE03/01811

§ 371 Date: May 9, 2006

(51) Int. Cl. H04B 1/06; H04B 7/00

(52) U.S. Cl. 455/276.1

(57) ABSTRACT

The invention relates to a method and a device for processing an electromagnetic signal comprising first and second carriers at first and second carrier frequencies. The method comprises splitting the signal into first and second branches, a first shifting of the frequency of the signal in each of the branches by respective first frequency shifts, and filtering the signal in the first and the second branch in respective first filters. In addition, there is a second shifting of the frequency in each of the branches by respective second frequency shifts, and a first frequency distance between the first frequency shifts, such that after the first shift, the first carrier in the first branch has essentially the same center frequency as the second carrier in the second branch. The first filters have the same filter characteristics, so that the signal in each branch after the first filter comprises only one of said first or second carrier wave, but at the same center frequency.

### TECHNICAL FIELD

The present invention relates to a device and a method for processing a received electromagnetic signal in the microwave range, the signal comprising at least a first and a second carrier wave at respective first and second carrier frequencies.

### BACKGROUND ART

There is a widely spread desire to use so called multi-carrier receivers within the WCDMA-technology (Wideband Code Division Multiple Access). Thus, there is a correspondingly great interest in designing such receivers in as cost-efficient a way as possible.

One known approach for the design of multi-carrier receivers is to split the signal early into an amount of branches corresponding to the number of carriers that is intended to be received. The signal is after the split treated as independent signals and the following circuitry therefore is very much a single-carrier receiver. This has the drawback that the number of components is nearly the same as for the same number of single-carrier receivers and thus the cost is only slightly reduced.

Another known approach to the design of multi-carrier receivers is based on a “single-carrier design” with an increased bandwidth to allow for “n-carrier” operation. However, due to imperfections in the filters available, this solution also has a number of drawbacks, mainly due to interference.

### SUMMARY OF THE INVENTION

There is thus a need for a method and a device by means of which a multi-carrier receiver can be designed in a more cost-efficient manner than previously.

This need is addressed by the present invention in that it provides a method for processing a received electromagnetic signal in the microwave range, with the signal comprising at least a first and a second carrier wave at respective first and second carrier frequencies. The method comprises splitting the received signal into a first and a second branch, and a first shifting of the carrier frequency of the signal in each of the branches by respective first frequency shifts, and also filtering the signal in the first and the second branch in respective first filters.

In addition, there is also a second shifting of the carrier frequency of the signal in each of the branches by respective second frequency shifts.

There is a first frequency distance between the first frequency shifts, such that after the first shift, the first carrier wave in the first branch has essentially the same center frequency as the second carrier wave in the second branch, thus enabling the use of first filters which have essentially the same filter characteristics, so that the signal in each branch after the first filter comprises only one of said first or second carrier wave, but at essentially the same center frequency.

Suitably but not necessarily, the second frequency shifting is carried out by different shifts in each of the branches, the difference between the shifts in the branches corresponding to a desired frequency separation between the first and the second carrier waves.

Thus, by means of the invention, the frequency separation between the first and second carrier waves can be set by those designing the system.

In a particularly preferred embodiment, the signals in the two branches are combined after the second frequency shifts, and then filtered and further processed.

### BRIEF DESCRIPTION OF THE DRAWINGS

The invention will be described in more detail in the following, with reference to the appended drawings, in which

FIG. 1 shows a block diagram of a first embodiment of the invention, and

FIG. 2 shows a block diagram of a version of the first embodiment of the invention, and

FIG. 3 shows a block diagram of a second embodiment of the invention, and

FIG. 4 shows a block diagram of a version of the second embodiment of the invention.

### EMBODIMENTS

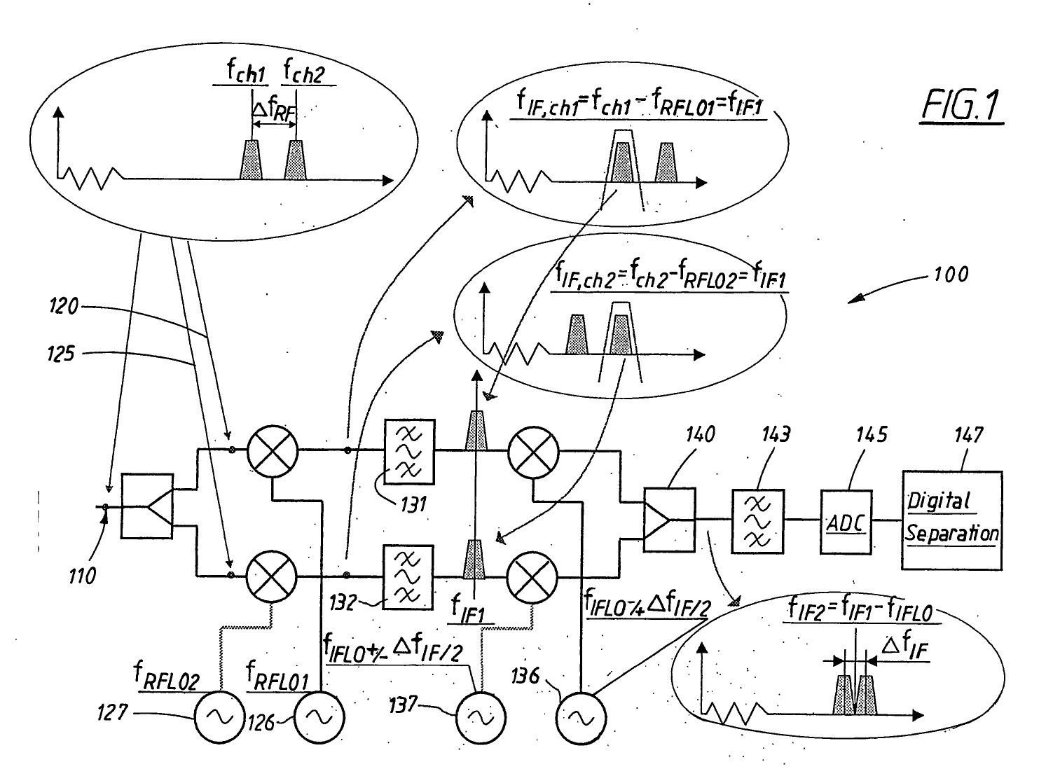

FIG. 1 shows a schematic block diagram of a first embodiment 100 of the present invention. The invention will throughout be described as a multi-carrier signal comprising two signals, but it will be appreciated by those skilled in the field that the invention can be applied to a multi-carrier signal comprising a more or less arbitrary amount of carriers. Thus, the two-carrier signal is only used as an example for the sake of clarity, and should not be seen as a restriction of the scope of the invention, which can be applied to a signal comprising more or less any amount of carriers.

A multi-carrier signal microwave frequency signal, preferably within a cellular telephony system employing WCDMA-technology, is received at an antenna 110. The signal comprises two carrier signals, at a first f₁, and a second f₂ carrier center frequency with a frequency separation between them referred to as AfRF. According to the invention, the received signal is split into a first 120 and a second 125 branch, so that the signal can be processed separately in each of the branches.

In each of the two branches, the signal is subjected to a first frequency shift by means of multiplication with the signal from a local oscillator, LO, one LO per branch, referred to as LO₁, 126, and LO₂, 127, with respective signals f_{LO1}, and f_{LO2}. The signal in the first branch is thus shifted by a shift of f_{LO1}, and the signal in the second branch by a shift of f_{LO2}.

One of the features of the embodiment of the invention shown in FIG. 1 is that there is a frequency distance between the two LO:s, the difference being such that after the first frequency shift, the center frequency of the first carrier in the first branch is essentially the same as that of the center frequency of the second carrier in the second branch. This is also illustrated in FIG. 1 by means of smaller drawings.

Following the first frequency shift in the first and the second branch, the signals are filtered in respective first filters, 131, 132, the filters preferably being of the bandpass type.

One of the ideas behind this embodiment of the invention will now become evident: since, at this stage in the signal processing, the center frequency of the first carrier wave on the first branch is essentially the same as that of the second carrier in the second branch, the bandpass filters in the first and the second branch can have the same pass band, or filter characteristics. This will thus result in a signal in the first branch which essentially comprises only the first carrier wave, and in the second branch in a signal which essentially comprises only the second carrier wave.

Following the first filtering, the signals in the first and the second branches are subjected to a second frequency shift, again by means of multiplication by the signals from respective LO:s, 136, 137, one in each branch. As the signals in the two branches at this stage in the signal processing are at basically the same center frequency, it is now desirable to shift them so that they are located at different center frequencies, but with a frequency separation between them which is defined by the system, or rather, chosen upon design of the particular circuit solution.

If the desired frequency separation between the two carrier waves is referred to as Δ_{IF}, the first and second LO frequencies respectively can suitably have the same frequency plus/minus “half the separation”, i.e. the two LO:s used for the second frequency shift can each have a “basic” frequency of f_{LO2} and then be separated from this by ±Δ_{IF}/2, where Δ_{IF} is the desired frequency separation between the two carrier waves after the second frequency shift.

Naturally, any frequency combination of the LO:s of the second shifting which will accomplish the desired frequency separation can be used, the frequencies and separations used in the example above are merely examples.

Thus, following the second frequency shifting in the two branches, the first carrier wave and the second carrier wave are now separated by Δ_{IF}. Suitably, the signals in the two branches are now combined into one branch, by means of a combining element 140.

Following this re-combination, the signal can then be filtered in a third bandpass filter 143, if it is desired to further filter out undesired components. After this, the re-combined signal is now ready for further desired processing, such as, in the application in FIG. 1, analogue to digital conversion, ADC, 145. Suitably, the frequency separation Δ_{IF} between the two carriers at this stage is adapted to the capacity of the ADC-circuit 145 used. In fact, this can be said to be another advantage of the present invention: the invention enables the use of simpler ADC:s, since the choice of frequency separation can be “tailored” to the ADC.

In addition, as a further advantage of the invention, only one ADC needs to be used, although there can be a plurality of carrier waves in the received signal. However, if it is for some reason desired not to do so, the signals in the two branches not need be combined after the second frequency shift, this is merely a preferred embodiment of the present invention.

As shown in FIG. 1, following the ADC, the signals can then be separated digitally in a circuit 147 for this, and processed.

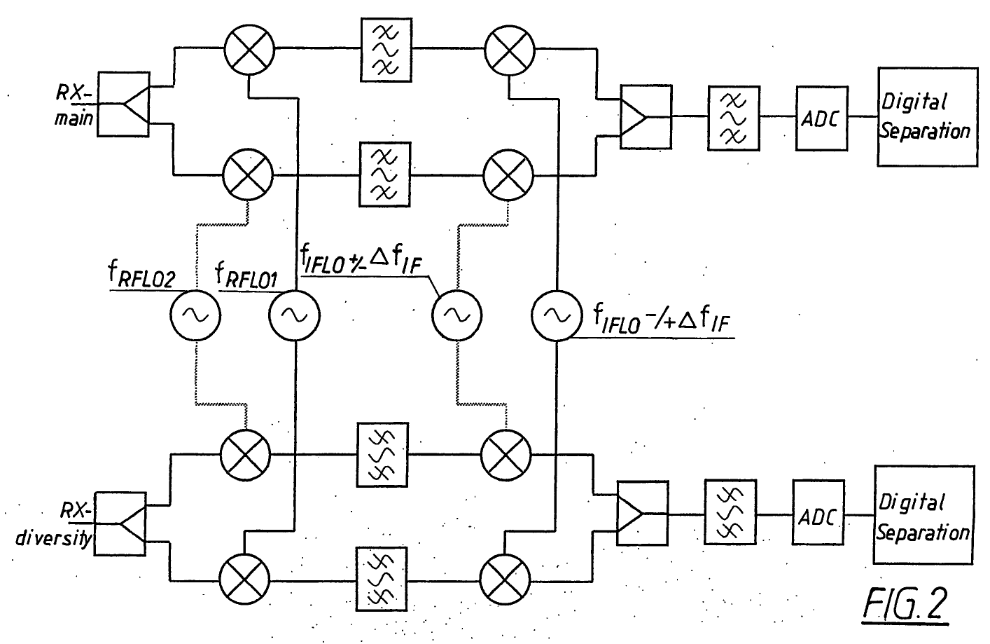

In FIG. 2, a more detailed diagram of a possible embodiment of the device from FIG. 1 is shown: The main difference between the embodiments of FIG. 1 and FIG. 2 is that the embodiment of FIG. 2 utilizes diversity reception, i.e. two antennas are used to receive the signal, with the signal comprising a plurality of carrier wave signals, in the example shown two such carrier waves. The circuit solution used in the case of two antennas and diversity reception can be essentially the same, so that the signal from each of the antennas is processed by circuits that are similar to each other.

Thus, in the example shown in FIG. 2, there are two signal processing chains, each of which contains the two branches shown in FIG. 1, where each of the chains is associated with one of the antennas, both chains being basically similar to the signal processing chain or circuit of FIG. 1. For this reason, the circuit solution of FIG. 2 will not be described in extensive detail here.

However, one detail of the solution of FIG. 2 can be highlighted: If the first and second frequency shifts in each of the two diversity chains are the same, there is no need for separate LO:s for each of the diversity chains. In the embodiment of FIG. 1, a total of four LO:s is used, two for the first frequency shift in each of the branches, and two for the second frequency shift in each of the branches. The same number of LO:s can be used in a diversity solution as shown in FIG. 2: one and the same LO can be used for the first frequency shift in the first signal processing branch in each of the diversity chains, and likewise for the second frequency shift in the second signal processing branch in each of the diversity chains.

Similarly, only two LO:s in total need to be used for the diversity solution shown in FIG. 2.

Naturally, with a diversity solution, the frequency shifts do not need to be the same in both of the diversity chains, as will be realized there is a large number of frequency shifts possible which would be suitable, but if the same frequency shifts are used, this will facilitate a low cost solution, since the number of LO:s can be kept to a minimum.

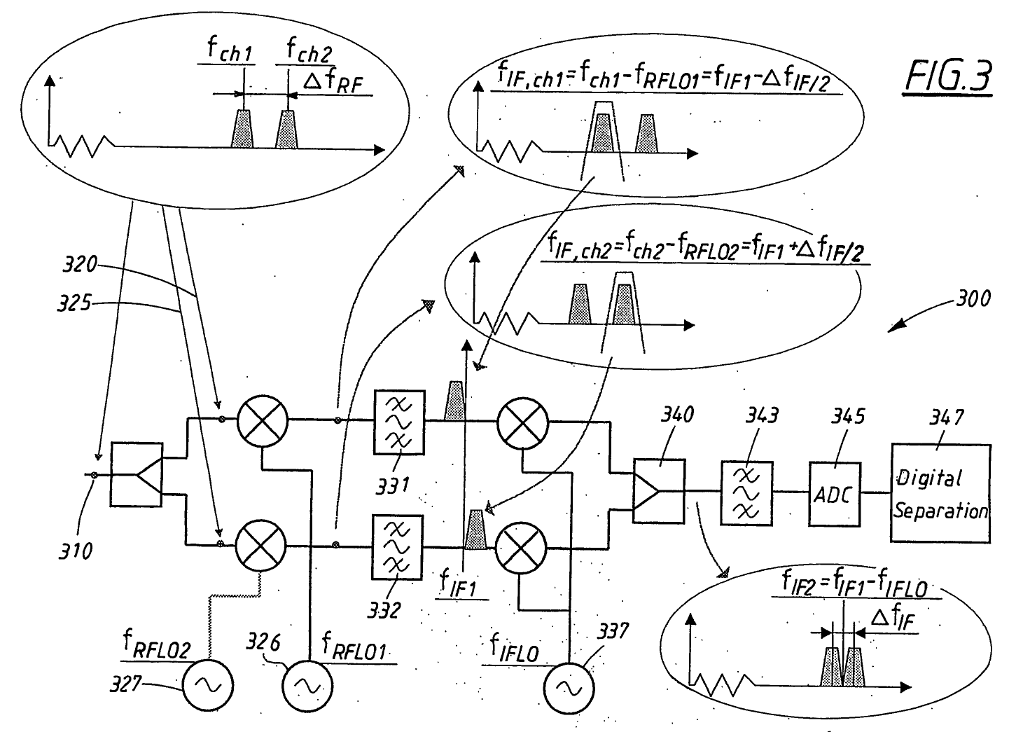

In FIG. 3, another embodiment 300 of the present invention is shown: in similarity to the embodiment shown in FIG. 1, the device of FIG. 3 receives a signal from an antenna 310, preferably a signal in the microwave range, and the device is especially useful in cellular telephony systems of the WCDMA-type.

The received signal is split into a first 320 and a second 325 branch, and the signal in each branch is frequency shifted by respective first frequency shifts, which is accomplished by a first LO 326, 327, for each of the branches. However, as opposed to the embodiment in FIGS. 1 and 2, the frequency shift in the embodiment shown in FIG. 3 is not designed to shift the first and the second carriers in the respective branches to the same center frequency. Rather, the first frequency shift in the two branches in this embodiment is aimed at giving the first and the second carrier waves in the first and second branch respectively different but well-defined center frequencies.

Following the first frequency shift in the first and the second branch, the signal in the two branches is then filtered, again preferably by means of band pass filters 331, 332, one in each branch. As opposed to the embodiments shown earlier, however, these band pass filters do not have the same pass band center frequency, although they might suitably have the same width of the pass band.

Although the first frequency shifts have resulted in differing shifts in the two branches, one of the purposes of this embodiment is, in similarity to the earlier shown embodiments, to leave only one of the received carrier waves in each of the branches.

For this reason, the filter 331 in the first branch has the center of its pass band essentially at the center frequency of the first carrier wave, and the filter 332 in the second branch has the center of its pass band essentially at the center frequency of the second carrier wave, with the width of the pass band in both of the filters being such that essentially all other components except the carrier wave are removed by the filter.

The first LO:s in the embodiment of FIG. 3 will be referred to as LO′₁, 326,and LO′₂, 327, with respective signals f′_{LO2}, and f′_{LO2}. The signal in the first branch is thus shifted by a shift of f′_{LO1}, and the signal in the second branch by a shift of f′_{LO2}.

Thus, following the frequency shifting and filtering, again there is only one carrier wave per branch. Naturally, these carrier waves can be processed separately, but preferably the two signals will be combined in a suitable manner. One such suitable manner will become evident from FIG. 3: since one of the purposes of combining the two signals is to place them at a well defined frequency spacing from each other, the two signals are subjected to a second frequency shifting. However, since the two signals now do not have the same center frequency, they can be shifted by the same amount without coinciding.

Thus, only one LO 337 is needed for the shifting in both of the branches. The signal from this LO 337 is referred to as f_{IFLO}, and is used for multiplication in both branches. Following this second shifting by f_{IFLO}, the first and the second carrier waves are suitably combined in a combiner unit 340 , and the total signal is then further processed, for example filtered in a band pass filter 343.

The distance between the centre frequencies of the two carrier waves at this stage of the processing is one which has been carefully designed and calculated so that it is well known, and has, inter alia, been designed with the capacity of a subsequent ADC 345 in mind.

Following the conversion to digital representation by the ADC, the signals of the two carrier waves can then be separated digitally, and processed as needed.

Thus, the embodiment of FIG. 3 necessitates the need of band pass filters with different center frequencies, but on the other hand, one LO less is needed than in the embodiments of FIGS. 1 and 2.

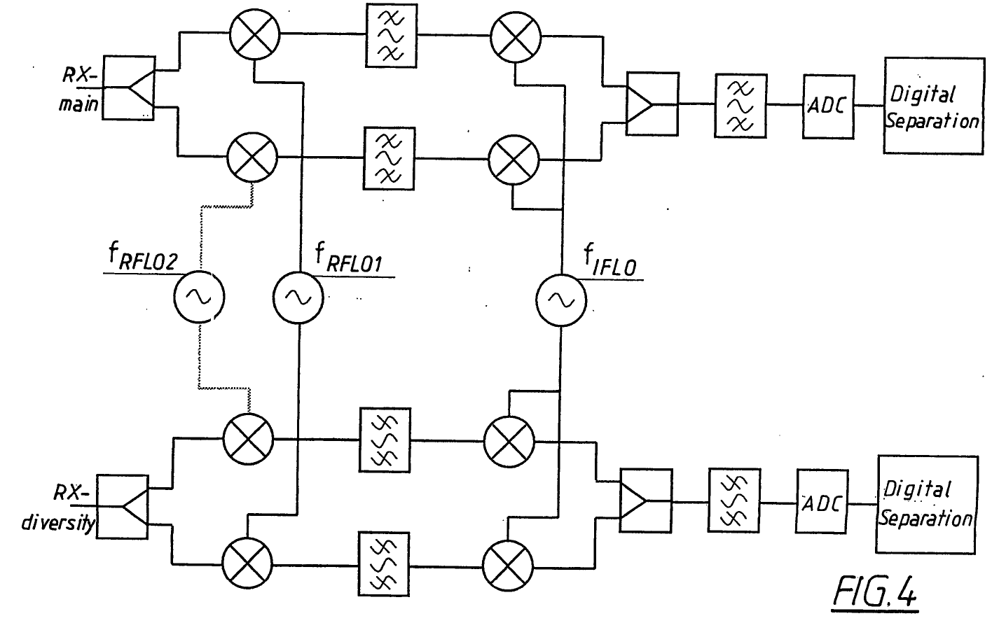

Finally, in FIG. 4, an embodiment based on the same principle as the one in FIG. 3 is shown, but with the difference that this embodiment utilizes diversity reception, similarly to the one in FIG. 2. Thus, since this principle was explained earlier, it will not be explained in detail here. However, due to the use of diversity reception, there are now four branches, two first branches and two second branches, one pair of branches for each of the two antennas used. Thus, for the first frequency shift, two LO:s are used, one for the two first branches and another one for the two second branches, with the frequencies as shown above, and again referred to as LO′₁ and LO′₂, with respective signals f′_{LO1} and f′_{LO2}.

Also, the signals in the respective first and second branches are filtered as in the embodiment of FIG. 3. However, following the filtering, since all of the signals are to be shifted the same amount, only one LO is needed to achieve the desired effect. The frequency of this LO is again referred to as f_{IFLO}, and is used for multiplication with the signals in all of the four branches.

Regarding the embodiments shown in FIGS. 3 and 4, it should be pointed out that in an alternative embodiment of the invention, the second frequency shifting could be omitted altogether.

Also, it should be pointed out that at least for the first frequency shift shown in all the embodiments, the use of two separate LO:s could be replaced by one LO which would only shift the signal in one of the branches, if that shift were calculated so that the distance between the signals in the first and second branches became the desired one.

1. A method for processing a received electromagnetic signal in the microwave range, the signal comprising at least a first and a second carrier wave at respective first and second carrier frequencies, comprising:
splitting the received signal into a first and a second branch,
a first shifting of the carrier frequency of the signal in each of the branches by respective first frequency shifts,
filtering the signal in the first and the second branch in respective first filters
a second shifting of the carrier frequency of the signal in each of the branches by respective second frequency shifts, which method is characterized in that
there is a first frequency distance between the first frequency shifts, such that after the first shift, the first carrier wave in the first branch has essentially the same center frequency as the second carrier wave in the second branch,
the first filters have essentially the same filter characteristics, so that the signal in each branch after the first filter comprises only one of said first or second carrier wave, but at essentially the same center frequency.

2. The method of claim 1, according to which the second frequency shifting is carried out by different shifts in each of the branches, the difference between the shifts in the branches corresponding to a desired frequency separation between the first and the second carrier waves.

3. The method of claim 1, according to which the signals in the two branches are combined after the second frequency shifts, and then filtered and further processed.

4. A device for processing a received electromagnetic signal in the microwave range, the signal comprising at least a first and a second carrier wave at respective first and second carrier frequencies, the device comprising:
means for splitting the received signal into a first and a second branch,
means for a first shifting of the carrier frequency of the signal in each of the branches by respective first frequency shifts,
means for a first filtering of the signal in the first and the second branch respectively,
means for a second shifting of the carrier frequency of the signal in each of the branches by respective second frequency shifts, which device is characterized in that
in the means for the first frequency shifts, there is a first frequency distance between the first frequency shifts, such that after the first shift, the first carrier wave in the first branch has essentially the same center frequency as the second carrier wave in the second branch,
the means for the first filtering have essentially the same filter characteristics, so that the signal in each branch after the first filter comprises only one of said first or second carrier wave, but both being placed at essentially the same center frequency.

5. The device of claim 4, in which the means for the second frequency shifting employ different shifts in each of the branches, the difference between the shifts in the branches corresponding to a desired frequency separation between the first and the second carrier waves.

6. The device of any of claim 5, further comprising means for combining the signals in the two branches after the second frequency shifts, and also means for their filtering and further processing.

7. A method for processing a received electromagnetic signal in the microwave range, the signal comprising at least a first and a second carrier wave at respective first and second carrier frequencies, comprising:
splitting the received signal into a first and a second branch,
a first shifting of the carrier frequency of the signal in each of the branches by respective first frequency shifts,
filtering the signal in the first and the second branch in respective first filters
a second shifting of the carrier frequency of the signal in each of the branches by second frequency shifts, which method is characterized in that
the first filtering in the first and second branch filters out one of the carrier waves in each branch, so that each branch, after the first filter, comprises only one of the carrier waves, and in that
the second shift is carried out by the same shift amount in both of the branches.

8. The method of claim 7, according to which the signals in the two branches are combined after the second frequency shifts, and then filtered and further processed .

9. A device for processing a received electromagnetic signal in the microwave range, the signal comprising at least a first and a second carrier wave at respective first and second carrier frequencies, said device comprising:
means for splitting the received signal into a first and a second branch,
means for a first shifting of the carrier frequency of the signal in each of the branches by respective first frequency shifts,
means for a first filtering of the signal in the first and the second branch respectively,
means for a second shifting of the carrier frequency of the signal in each of the branches by second frequency shifts, which device is characterized in that
the means for the first filtering in the first and second branch filters out one of the carrier waves in each branch, so that each branch, after the first filter, comprises only one of the carrier waves, and in that
the means for the second shift carries out said second shift by the same shift amount in both of the branches.

10. The device of claim 9, comprising means for combining the signals in the two branches after the second frequency shifts, and then means for their filtering and further processing .
